(19) United States
(12) Patent Application Publication
(10) Pub. No.: US 2008/0234040 A1
(43) Pub. Date: Sep. 25, 2008

(54) GAMING SYSTEM WITH PROMOTIONAL FEATURE

(75) Inventor: Clive Evan Davies, Oatlands (AU)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY, LTD, Lane Cove NSW (AU)

(21) Appl. No.: 12/050,617

(22) Filed: Mar. 18, 2008

(30) Foreign Application Priority Data
Mar. 19, 2007 (AU) 2007901410

(51) Int. Cl. G06F 17/00

(52) U.S. Cl. 463/26; 463/42; 463/31

(57) ABSTRACT

A method is described for running a feature on a gaming system comprising a plurality of gaming consoles linked by a communication network. The method includes defining a spatial sequence for the plurality of gaming consoles and running a feature in which at least one of the gaming consoles is selected as a terminus. The gaming consoles are activated in turn to emit a predefined output, the activation cycling through the gaming consoles according to the spatial sequence. The cycle of activation halts at the terminus.

### CROSS-REFERENCE TO RELATED APPLICATIONS

This application claims priority to Australian Provisional Patent Application No. 2007901410, having an international filing date of Mar. 19, 2007, entitled “Gaming System With Promotional Feature,” which is hereby incorporated by reference herein in its entirety.

### FIELD OF THE INVENTION

The present invention generally relates to gaming machines and methods of gaming. A particular embodiment of the present invention relates to a player-participation feature provided on a plurality of linked gaming machines.

### BACKGROUND OF THE INVENTION

With the increase of gambling at gaming venues has come increased competition between gaming venues to obtain a larger share of the total gambling spend. Gaming venue operators have therefore continuously looked for new variations and types of games to enhance the entertainment value of the games offered at their venues.

In response to this need, suppliers of gaming devices and systems have attempted to provide the sought after variety, while still developing games that comply with the relevant regulations in the jurisdiction of the gaming venue operator. Suppliers of gaming devices therefore are faced with restrictions on the types of games and gaming machines that are allowable, both in terms of the prevailing regulations and in terms of providing a return on investment to the gaming venue operators.

Any reference in this specification to the prior art does not constitute an admission that such prior art was well known or forms part of the common general knowledge in any jurisdiction.

### SUMMARY OF THE INVENTION

According to a first aspect of the invention there is provided a method of running a feature on a gaming system comprising a plurality of gaming consoles linked by a communication network, the method comprising:

defining a spatial sequence for the plurality of gaming consoles;

selecting at least one of the gaming consoles as a terminus;

activating the gaming consoles in turn to emit a predefined output, the activation cycling through the gaming consoles according to the spatial sequence; and

halting the cycle of activation at the terminus.

The method may comprise awarding a prize to a player at the terminus.

The predefined output emitted by the gaming consoles may be selected from the group consisting of:

a visible output from a source of illumination on the gaming consoles having a specified duration; and

an audible output from a sound source on the gaming consoles.

The plurality of gaming consoles may be a subset of a larger group of gaming consoles and the method comprises designating the plurality of gaming consoles as participating machines for the feature.

The method may comprise offering players at the participating machines the option of entering the feature.

The method may comprise offering players the option of multiple entries into the feature.

The at least one terminus may be selected from participating machines at which at least one entry into the feature has been received.

Each entry may provide an equal chance of selection as a terminus.

The method may comprise charging an entry fee for each entry into the feature.

The entry fee may be deducted from promotional credits accumulated by players at the gaming consoles.

In one arrangement the method may comprise adding received entry fees to a jackpot.

The prize may include at least one of:

promotional credits drawn from the jackpot; and

prizes from a prize list.

In one arrangement the spatial sequence may comprise a plurality of paths through the plurality of gaming consoles and said activating step activates two or more paths concurrently.

The step of selecting a terminus may select a plurality of participating machines.

In one arrangement the method may comprise receiving an input from a player at one of the gaming consoles and checking whether the input coincides with a specified interval during which the gaming console is activated in said activating step.

The method may comprise awarding a reward if the input coincides with the specified interval.

The method may comprise stopping the cycle of activation at a gaming console if an input is received to coincide with the specified interval.

The method may comprise increasing the specified interval as the cycle of activation progresses.

The cycle of activation may have a definable interval between activation of sequential gaming consoles, the definable interval being variable over the cycle of activation.

The cycle of activation may slow down prior to halting of the cycle.

According to a further aspect of the invention there is provided a method of running a feature on a gaming system comprising a plurality of gaming consoles, the method comprising:

defining a pathway associated with the plurality of gaming consoles;

activating a visual sequence that follows the pathway;

halting the visual sequence at a selected location on the pathway;

designating one of the gaming consoles associated with the selected location as a winning console in the feature.

The pathway may be a spatial sequence of the gaming consoles and the visual sequence comprises activating sources of illumination of the gaming consoles according to the spatial sequence.

The pathway may comprise a track of light sources proximate to the plurality of gaming consoles and the visual sequence comprises sequentially activating light sources along the track.

In one arrangement the pathway may comprise a physical track proximate to the plurality of gaming consoles and the visual sequence comprises movement of an object along the physical track.

According to a further aspect of the invention there is provided a gaming system comprising:

a plurality of gaming machines comprising light-emitting outputs and audio outputs; and

a computational device in communication with the plurality of gaming machines and programmed to:

define a spatial sequence for the gaming machines;

select at least one of the gaming consoles as a terminus;

activate the gaming consoles in turn to emit a predefined output, the activation cycling through the gaming consoles according to the spatial sequence; and

halt the cycle of activation at the terminus.

According to further aspects, the invention broadly resides in instructions executable by a game controller to implement the method as described in the preceding paragraphs and to such instructions when stored in a storage medium readable by the game controller.

Further aspects of the present invention will become apparent from the following description, given by way of example only and with reference to the accompanying drawings.

### BRIEF DESCRIPTION OF THE DRAWINGS

Certain embodiments will now be described to illustrate the invention in relation to the accompanying drawings, in which:

FIG. 1: shows a view of a gaming console suitable for implementing certain embodiments of the present invention.

FIG. 2: shows a block diagram of a gaming machine suitable for implementing certain embodiments of the present invention.

FIG. 3: shows a block diagram of components of the memory of the gaming machine represented in FIG. 2.

FIG. 4: shows schematically a network gaming system suitable for implementing certain embodiments of the present invention.

FIG. 5: shows a flow diagram of a method of setting up a promotional feature on a system of gaming machines.

FIG. 6: shows a flow diagram of a version of the feature having manual override functions.

FIG. 7: shows a flow diagram of a method of running the promotional feature on a system of gaming machines.

FIG. 8: shows a schematic diagram of banks of gaming consoles and an associated pathway defining the route of a chaser sequence.

### DETAILED DESCRIPTION

A promotional feature for a system of gaming machines is described in which a sequence of chasing lights and sound moves across a plurality of gaming machines to settle on one or more winning machines.

Operating Environment

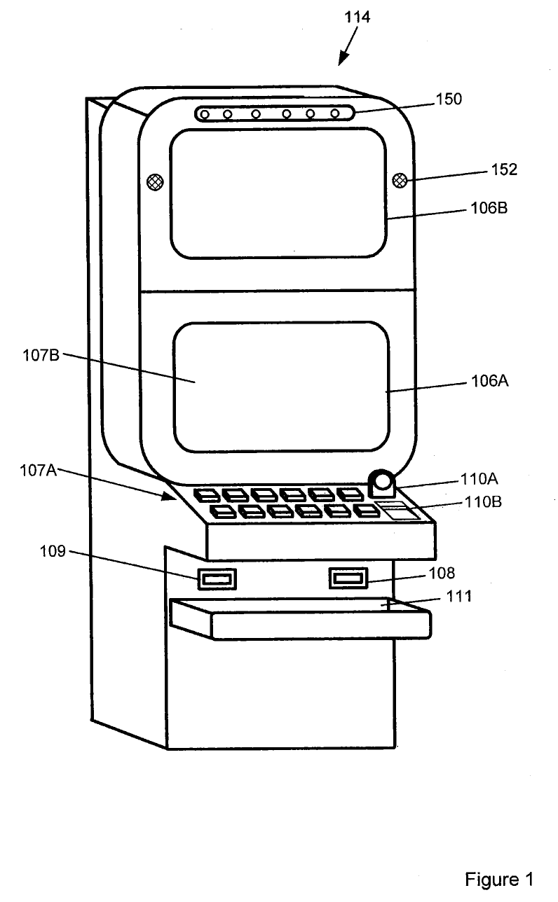

In FIG. 1 of the accompanying drawings, one example of a gaming console that is suitable to implement certain embodiments of the present invention is generally referenced by arrow 114.

The gaming console 114 includes two displays 106A, 106B on one or both of which is displayed representations of a game that can be played by a player and a bank of buttons 107A and/or a touch screen 107B to enable a player to play the game. The displays 106 may be video display units, such as a cathode ray tube screen device, a liquid crystal display, plasma screen, any other suitable video display unit, or the visible portion of an electromechanical device. The display 106B may display artwork, including for example, pay tables and details of bonus awards and other information or images relating to the game. In alternative gaming consoles the display 106B may be omitted, optionally replaced by a static display.

A credit input including a coin input 110A and/or bill collector 110B allows a player to provide credit for wagering and a coin output 111 is provided for cash payouts from the gaming console 114. A card and/or ticket reader 108 and a printer 109 may be provided to provide player tracking, cashless game play or other gaming and non-gaming related functions.

The gaming console 14 also includes one or more speakers and/or buzzers 152. In addition to the displays 106, the gaming console 114 may include one or more illumination devices such as light-emitting diodes (LEDs) 150 or electro-fluorescent signage. The speakers may be used to convey audible information to a player at the gaming console 114. In addition, the speakers and buzzers 152 may be used to play music to attract attention or to accompany the gaming features presented on the gaming console 114.

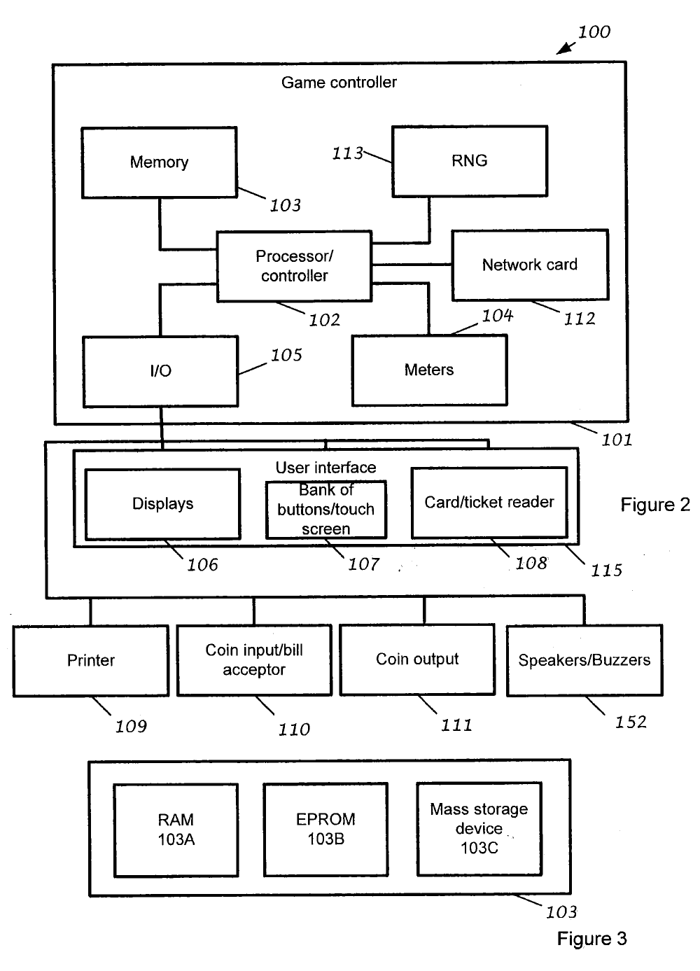

FIG. 2 shows a block diagram of a gaming machine, generally referenced by arrow 100, suitable for implementing certain embodiments of the present invention. The gaming machine 100 may include the gaming console 114 shown in FIG. 1 and accordingly like reference numerals have been used to describe like components in FIGS. 1 and 2.

The gaming machine 100 includes a game controller 101, which in the illustrated example includes a computational device 102, which may be a microprocessor, microcontroller, programmable logic device or other suitable device. Instructions and data to control operation of the computational device 102 are stored in a memory 103, which is in data communication with, or forms part of, the computational device 102. Typically, the gaming machine 100 will include both volatile and non-volatile memory and more than one of each type of memory, with such memories being collectively represented by the memory 103. The instructions to cause the game controller 101 to implement the present invention will be stored in the memory 103. The instructions and data for controlling operation of the computational device 102 may be stored on a computer readable medium from which they are loaded into the gaming machine memory 103. The instructions and data may be conveyed to the gaming machine by means of a data signal in a transmission channel. Examples of such transmission channels include network connections, the Internet or an intranet and wireless communication channels.

The game controller 101 may include hardware credit meters 104 for the purposes of regulatory compliance and also include an input/output (I/O) interface 105 for communicating with the peripheral devices of the gaming machine 100. The input/output interface 105 and/or the peripheral devices may be intelligent devices with their own memory for instructions and data.

In the example shown in FIG. 2, the peripheral devices that communicate with the controller are the displays 106, bank of buttons/touch screen 107, the card and/or ticket reader 108, the printer 109, a bill acceptor and/or coin input 110 and a coin output 111. Additional devices may be included as part of the gaming machine 100, or devices omitted as required for the specific implementation.

The peripheral devices may include one or more speakers and/or buzzers 152 that are in data communication with game controller 101 via an input/output unit such as I/O 105. Consequently, the audio information presented on the buzzers and/or speakers may be controlled by software running on the game controller 101. In addition, where the gaming machine 100 includes other illumination means such as banks of LEDs 150, such illumination may be switched on or off by instructions transmitted by the game controller 101. The illumination devices may be individually controllable.

The bank of buttons 107A and/or touch screen 107B together with one or both of the displays 106 may provide a user interface 115 through which the gaming machine 100 and player communicate. If a card/ticket reader 108 is provided, this may also form part of the user interface 115.

In addition, the gaming machine 100 may include a communications interface, for example a network card 112. The network card 112, may for example, send status information, accounting information or other information to a central controller, server or database and receive data or commands from a the central controller, server or database. The network card 112 may also enable communication with a central player account, allowing cashless gaming. One or more of the peripheral devices, for example the card/ticket reader 108 may be able to communicate directly with the network card 112. The network card 112 and the I/O interface 105 may be suitably implemented as a single machine communications interface.

The game controller 101 may also include a random number generator 113, which generates a series of random numbers that determine the outcome of a series of random game events played as part of a game on the gaming machine 100.

The game controller 101 may have distributed hardware and software components that communicate with each other directly or through a network or other communication channel. In particular, the game controller 101 may be located in part or in its entirety remote from the user interface 115. Also, the computational device 102 may comprise a plurality of devices, which may be local or remote from each other.

FIG. 3 shows an exemplary block diagram of the main components of the memory 103. The RAM 103A typically temporarily holds instructions and data related to the execution of game programs and communication functions performed by the computational controller 102. The EPROM 103B may be a boot ROM device and/or may contain system and game related code. The mass storage device 103C may be used to store game programs, the integrity of which may be verified and/or authenticated by the computational controller 102 using protected code from the EPROM 103B or elsewhere.

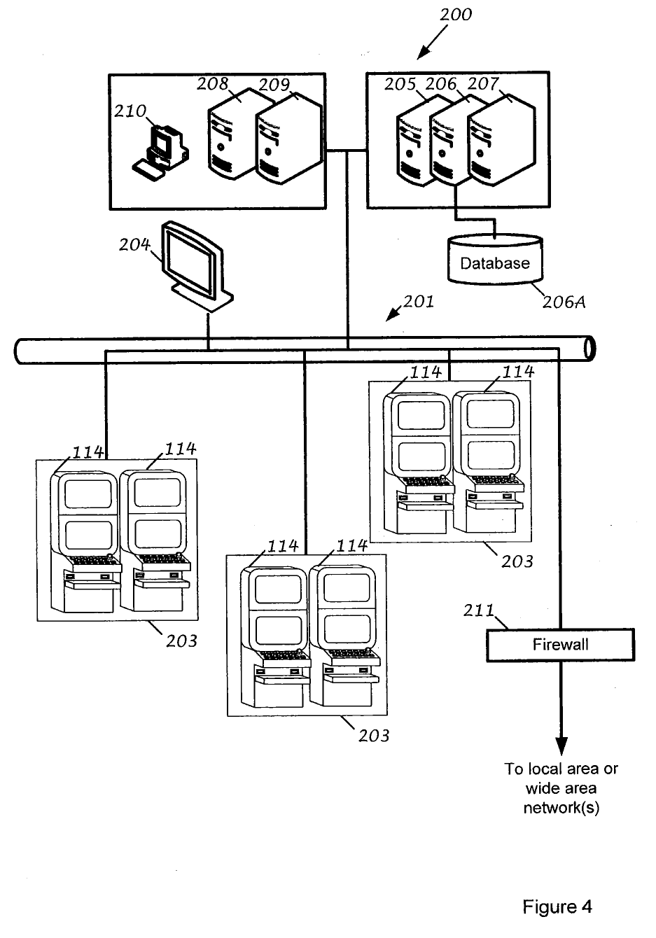

FIG. 4 shows a gaming system 200 in the form of a network of devices. The gaming system 200 includes a network infrastructure 201, which for example may be an Ethernet network. Alternatively, a wireless network and/or direct communication channels, or a different type of network may be used to link the gaming machines to a server, each other and/or other devices. Gaming consoles 114, shown arranged in three banks 203 of two gaming consoles 114 in FIG. 4, are connected to the network infrastructure 201. The gaming consoles 114 may form part or all of a gaming machine 100. Single gaming consoles 114 and banks 203 containing three or more gaming devices 202 may also be connected to the network infrastructure 201, which may also include hubs, routers, bridges to other networks and other devices (not shown).

One or more displays 204 may also be connected to the network 201. The displays 204 may, for example, be associated with a bank 203 of gaming consoles 114. The displays 204 may be used to display representations associated with game play on the gaming devices 202, and/or used to display other representations, for example promotional or informational material.

Servers may also be connected to the network 201. For example, a game server 205 may generate game outcomes for games played on one or more of the gaming consoles 114, a database management server 206 may manage the storage of game programs and associated data in a database 206A so that they are available for downloading to, or access by, game controllers 101, and a jackpot server 207 may control one or more jackpots for the gaming system 200.

Further servers may be provided to assist in the administration of the gaming system 200, including for example a gaming floor management server 208, and a licensing server 209 to monitor the use of licenses to particular games. An administrator terminal 210 is provided to allow an administrator to manage the network 201 and the devices connected to the network.

The gaming system 200 may communicate with other gaming systems, other local networks, for example a corporate network and/or a wide area network such as the Internet through a firewall 211.

Setting Up the Promotional Feature

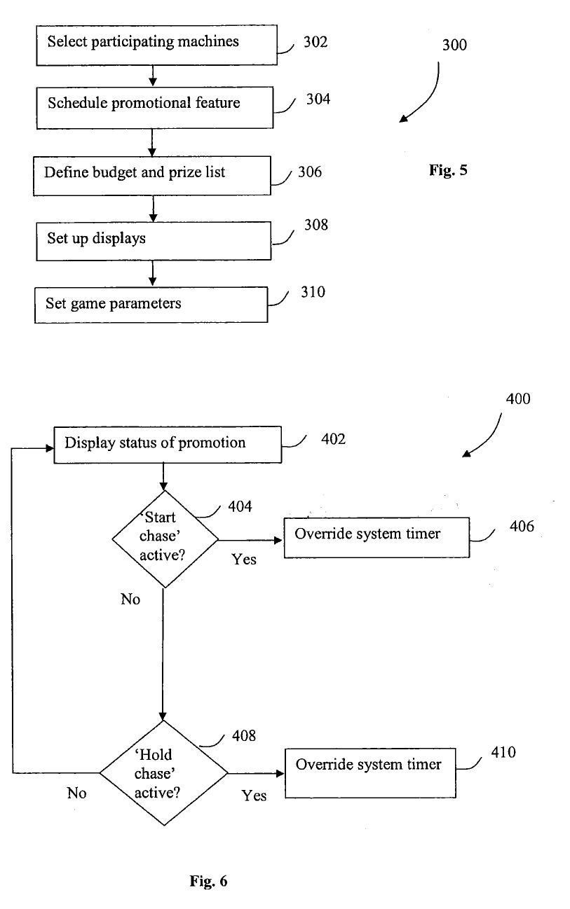

FIG. 5 illustrates a method 300 of setting up the promotional feature. The steps of method 300 will be typically implemented by software running on one or more servers in the gaming system 200. A user interface is provided on a terminal such as administrator terminal 210 that enables a user to enter the desired parameters of the feature.

In step 302, the set up software provides an interface that enables a user to select a group of specific gaming machines 114 to participate in the promotional feature. The participating machines may include multiple device types, including poker machines, cash registers, entrance machines, blackjack tables, roulette, poker machines, keno terminals and sports book terminals. A radio button may allow for the inclusion of multiple device types into any one promotional event. Each device type can be further defined into groups and sub-groups. By presetting the group associations in database applications relating to the machines, it is possible to assign a promotional event to many different combinations of networked devices.

A spatial sequence of participating machines is used in the promotional feature. Typically, the spatial sequence includes series of adjacent gaming consoles. The sequence may be determined by attributes of the gaming system 200 stored in databases such as database 206A. The spatial sequence depends on the physical layout of the gaming consoles 114 in the gaming room. A chaser sequence, described below, activates gaming consoles 114 in turn according to the spatial sequence. Preferably, a viewer in the gaming room should be able to perceive the chaser sequence as a simulated motion from console to console. In one arrangement the spatial sequence may be set up by the user in step 302. Alternatively, the spatial sequence may be automatically determined once the user has selected the groups of participating machines. A graphic user interface may show a map of the layout of gaming consoles 114 in a gaming venue. The user may define a spatial sequence of consoles using the displayed map, for example by touching on different banks of consoles in turn to specify the sequence. The setup software may correlate the spatial sequence to the network addresses of the gaming consoles 114, permitting messages to be sent over network 210 to activate the consoles 114 according to the spatial sequence.

In some arrangements the spatial sequence may define multiple paths through the participating machines. The chaser sequence may activate multiple paths concurrently to simulate the movement of multiple objects through the gaming room.

In step 304, software running on the administration terminal 210 provides the user an interface for determining one or more time periods in which the promotional feature will operate on the selected group of gaming machines 114. A calendar selection may be provided to allow the user to define a start and end date for the promotional event. Within the specified calendar period, the user is able to define specific time periods. For example, the user may specify that the promotion is to run each Monday between 10 am and midday and again on Mondays from 2 pm to 4 pm.

In step 306 software running on administrator terminal 210 enables the user to define a budget and prize list for the promotion. For example, the user may specify or forecast the budgeted value for the entire promotional period. The software determines the actual number of promotional sessions within the promotional period and calculates the amount of money that can be spent in each session in order to stay within the overall budget. The software also enables the user to determine the anticipated staff costs of running the promotional feature.

In step 306 the user is able to specify a list of prizes to be offered during the promotional feature. In other arrangements no prize list is established and the winner of the promotional feature is awarded a jackpot of promotional credits. Alternatively, the prize may be a combination of accumulated promotional credits and prizes from a prize list. Where prizes are offered in addition to a jackpot of credits, the interface software allows the user to specify a 32-character description of the prize. This description may, for example, be used to describe the prize on offer on networked display screens that each show two lines of 16 characters. A detailed description may also be used to describe the prize on other networked signage such as display 204. The software may also allow the user to specify a final collection date before which the item must be collected by the player. The setup software also enables the user to provide a photograph of an item in the prize list. The photograph may be provided, for example, either from a computer file or directly from a digital camera. The image of the prize may be displayed in the course of the promotional feature on displays 204 or on the displays of the individual gaming consoles 114.

In step 308 the user is provided with an interface to design screens for display associated with the promotional feature. For example, advertising and marketing material may be displayed prior to the promotion, or during the promotion. The interface display prompts the user by indicating the different types of screens that should be designed before the promotional feature is run. The message types may include:

“session pending” messages;

“event in progress” messages;

“current prize on offer” message; and

“winner” messages.

The available formats for each of these messages may depend on the type of participating machines selected in step 302. For example, a more elaborate message may be designed for display on a plasma screen then would be appropriate for other types of screens such as a two line×16 character LCD screen. The user may also determine sound and light sequences to accompany the messages. The results of the graphic design are displayed to the user at the administrator terminal 210 so that the user can see the finished effect of the design. The user interface may display a list of pre-made graphics to use as background images on displays. A selection of text themes may also be displayed to provide a variety of colour, size and formatting display options. Various animation options may also be displayed for presentation of the text content of the message.

In some arrangements players at the gaming consoles 114 may be provided with individual cards that contain, for example, information identifying the player or details of accumulated credits. For such systems, the user in step 308 is provided with the option of designing messages associated with the insertion or removal of the individual cards. For example, when a new card is inserted into a gaming console 114, a welcome message may be presented to the player together with information about how the promotional feature functions. Associated messages may describe the current prize on offer and give information about the player's current status. Similarly, when a card is removed a goodbye message may be displayed and, if appropriate, a message for the user to collect a prize. The content and design of these messages may be set up by the user in step 308.

As described in more detail below, the promotional feature involves a simulated chaser sequence in which sound and light signals are perceived to move from console to console in the gaming system 200. After moving around the gaming floor for a time, the chaser sequence terminates on one or more winning consoles. In step 310, the set up software provides the user at administrator terminal 210 with a series of options that specify various parameters of the feature involving the chaser sequence. The parameters determine display and timing features of the chaser sequence, together with probabilities of the feature and decisions about how players pay for entry into the feature.

One parameter determines whether the reward in the promotional feature includes:

promotional credits;

prizes from a prize list; or

prizes and promotional credit.

Another parameter determines how much a player must pay to enter the promotional game. There may be a fixed charge of promotional credits for each entry into the game. Alternatively, upper and lower limits may be set and the software running the promotional feature selects a value at random between the upper and lower limits. In this arrangement, each time a new game sequence starts a different value may be charged to enter the promotional feature. Players may choose whether or not to participate.

Another parameter determines a waiting time between the start of the game and the initiation of the chaser sequence. Players may enter the game during this waiting period, and a jackpot of promotional credits accumulates as the players enter the game.

A farther parameter sets a maximum limit to the number of simultaneous winners. For example, the user may specify that three winners result from each chaser sequence. Another parameter determines how many times a player may enter the promotional feature. Increasing the number of entries increases the player's chance of winning the promotional feature.

A further parameter determines whether or not players are offered a double-up option when playing the promotional feature.

A further option determines whether manual validation of a win is required. If this option is selected, a manually-validated payment procedure must be completed before the current game ends and a new promotional game can start. The manual validation can take place by pressing an appropriate paging button, by using a proximity tag or by keying in a password, depending on the particular hardware used in the gaming system 200.

When the chaser sequence is initiated, all machines selected in step 302 will begin to flash and buzz, whether or not the machines are eligible to win the current promotional feature. The effect of the chaser sequence is of a moving wave of sound and light that cycles around the predefined spatial sequence. Parameters entered in step 310 determine the sound and light activity of machines activated in the chaser sequence. The parameters determine the cycle time of the chaser sequence and the flash time of each machine when activated. For example, machines may bet set to flash for 30 seconds when activated during the chaser sequence. The speed of flashing may also be specified, together with the type of sound emitted while the machine is flashing. The speed of movement around the room may be specified, and also the rate of slowing as the chaser sequence approaches the winning console.

Running the Promotional Feature

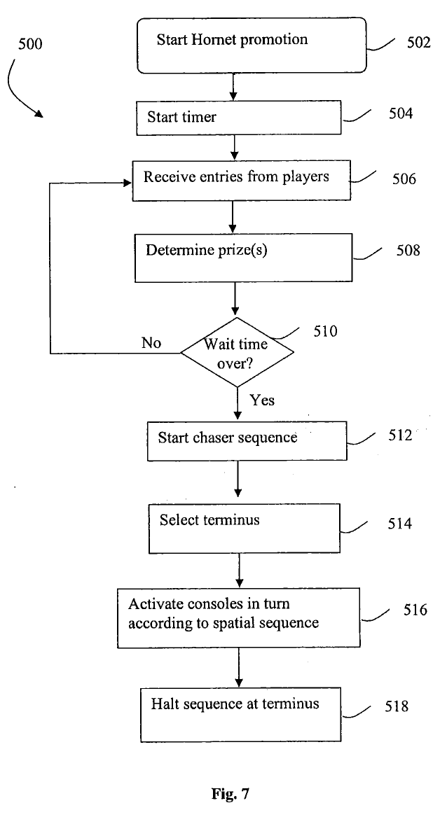

FIG. 7 illustrates a method 500 of running the promotional feature on gaming system 200. The gaming feature is typically coordinated by software running on one or more servers attached to the network infrastructure 201, for example game server 205. Distributed software may also be used, for example making use of computational devices 102 within one or more of the gaming consoles 114.

In step 502 the promotional feature commences in accordance with the schedule specified by the user in step 304 of method 300. The specified parameters of the promotion determine which of the gaming consoles 114 participate in the promotional feature. Prior to the feature commencing, messages alerting players to the forthcoming feature may be displayed, for example on displays 204 or the individual displays of the gaming consoles 114.

In step 504 the timer that counts the wait time is initiated and displayed on signage that is visible to players of the participating machines. While the timer is counting down, players at the participating machines may indicate that they wish to enter the upcoming promotion. The game begins with the display of the promotional parameters on gaming interface displays, overhead signage and/or by automatic audible announcements. The players participate in the game by spending promotional credit. Once a player has entered, the display of the player's gaming console 114 will indicate that the player is eligible in the forthcoming game. Different games may require different entry fees, for example chosen at random within a pre-selected range. Players can enter a game as many times as they like (up to a predetermined maximum) and each entry represents an equal chance to win the feature.

In step 508 the coordinating software determines the total contribution of all participating players. This total becomes the reward and the reward value may be displayed on the participating devices. In addition, prizes from a prize list may be offered as rewards in the forthcoming feature. Information about the current prizes may also be displayed on individual gaming consoles or general overhead displays 204.

In step 510 the coordinating software checks whether the wait time is over. If not, process flow returns to step 506 to await further entries from players at participating machines. If the wait time is over (the Yes option of step 510) then in step 512 the chaser sequence is set in motion. As an alternative to waiting until the wait time is over, the chaser sequence may be commenced when the prize pool has reached a pre-set threshold.

In step 514 at least one of the eligible gaming consoles is selected at random as a terminus for the chaser sequence. Consoles become eligible for selection when a user at the console enters the feature. The selection of the terminus may occur at different stages of the method 500 in different implementations. For example, the terminus may be selected before the chaser sequence commences, or the terminus may be selected during the chaser sequence.

In step 516 the controlling software activates speakers, beepers and flashing LEDs on participating machines so that each of the participating gaming consoles 114 will sequentially flash and buzz, whether or not a user at the machine has entered the game. The effect of the sequence is of a moving wave of sound and lights. In one implementation the sequence is given the name “Hornet” which derives from the sound that the system makes as each gaming console 114 buzzes and the sound sequence moves around the room. The spatial sequence is pre-set and the coordinating software activates each of the participating gaming consoles 114 in turn according to the preset schedule. All machines initially sequence and the sound and light wave will move along consecutive machines for a preset time. In one arrangement software on a game server 205 sends activating messages to the participating consoles 114 over the network infrastructure 201.

After this period has ended, the sequence gradually slows down and ultimately, in step 518, halts on a winning console selected at random from the eligible consoles. Alternatively, depending on the parameters set earlier, there may be more than one winning machine. Where more than one entry has been registered for a gaming console 114, the sequence will flash a corresponding number of times at the gaming console 114. When the chaser sequence stops on a winning console, the console continues to flash and buzz, or to play a winner tune, for a period. The value of the prize may be displayed on the screen of the winning console 114, or on overhead signage such as displayed 204. The promotional points in the reward may then be transferred to the player's account and the game reset ready for a further round.

It will be appreciated that the physical route followed by the chaser sequence may be pre-specified depending on the layout of the gaming room. In some arrangements there may be multiple sequences chasing simultaneously through the gaming room. Such sequences may be pre-specified in attributes of the gaming system 200 stored in a database such as database 206A.

There are various ways in which players at gaming consoles 114 may accumulate promotional credits to use in entering the promotional features. Players may be awarded a start-up amount of promotional credit at the beginning of a session or, for example, when a card is issued to the player. Players may also accumulate promotional credits in the course of normal game play on gaming consoles 114. For example, players may be awarded promotional credits for each dollar spent at the gaming consoles 114 and/or for each dollar won at the gaming consoles 114.

Player Participation in Chaser Sequence

In further arrangements, players are prompted to press a designated button on their gaming console 114 as the chaser sequence passes the console 114. Parameters specified in setting up the game determine an interval during which the player's activation of the button will register a hit as the chaser sequence passes. Clearly, the smaller the allowable interval the more difficult it will be to score a hit as the sequence passes. In a further arrangement, the permissible interval may gradually lengthen during the course of the chaser sequence. Thus, more skill may be required in the early stages of the chase, while it becomes easier to score a hit in the later stages of the sequence.

The entry process may be the same as that described above. Alternatively, arrangements may be used in which a player has promotional credits deducted each time the player activates the button to try and hit the chaser sequence. The sequence may halt immediately a player scores a hit. Alternatively, the chaser sequence may continue and the successful player may be awarded a reward of promotional points for hitting the chaser sequence as it passes.

Arrangement with Manual Override

The method described with respect to FIG. 7 is operated by coordinating software running on the gaming system 200. In a further arrangement, provision is made for the intervention of a compere or host. The host may help identify winners and encourage participation in the game. During the course of the promotional feature, the host is provided with access to a display connected to network infrastructure 201. A status screen is shown on the display to indicate the progress of the feature. The status screen informs the host what prizes are currently on offer and the value of the accumulated jackpot. The status screen shows the total number of machines in use in the allocated promotion area and the total number of user cards in use in the allocated promotion area. The status screen also displays the wait time remaining until the system is due to commence the chaser sequence.

This is illustrated in method 400 of FIG. 6. In step 402 the coordinating software displays the status of the promotional feature on the host's screen. In step 404 the coordinating software checks whether the host has activated a “start chase” button. If so, then in step 406 the system timer is overridden and the chaser sequence commences immediately.

In step 408 the coordinating software checks whether the host has activated a “hold chase” button. This button permits the host to delay the start of the chaser sequence. If the “hold chase” button has been activated, then in step 410 the coordinating software overrides the current system timer.

The gaming system 200 records and stores statistics relating to the promotional feature, allowing users to examine the performance of the promotions and to compare their performance over time. Historical reports may be configured by users, for example during method 300, in order to suit the requirements of different gaming venues and to provide a range of possible data examination.

For example, comparative history reports may allow any session or sessions to be compared over time to the same sessions in previous periods. Single session reviews may provide 15 minute data capture and results may be shown as graphs or listings or displayed immediately on the system screens, printed to hard copy or exported to spreadsheet files.

When setting up a promotional feature in step 300, a user need not always define the feature from scratch. Instead, the user may be offered the option of retrieving the parameters of a previous feature, and then editing the parameters to define the behaviour of a forthcoming promotion.

Gaming Consoles with Associated Pathway

In the previous description the chaser sequence is activated using output devices such as speakers and LEDs on the gaming consoles themselves. In alternative arrangements the chaser sequence progresses along a distinct pathway associated with the plurality of gaming consoles. The pathway may be a track of lights positioned above the gaming consoles, or a track of lights on the floor running past the gaming consoles 114. When the chaser sequence is activated, lights are sequentially activated along the track to give the impression of movement along the track. One or more terminal positions along the track may be randomly selected, and the chaser sequence slows down and stops at the terminal positions.

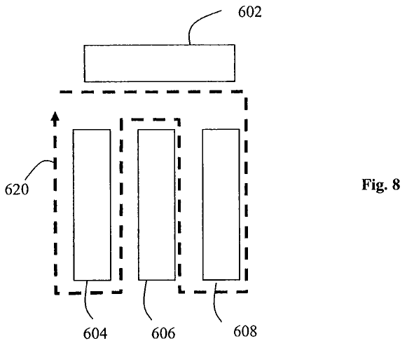

FIG. 8 shows an example of an arrangement having a pathway. A schematic top view is shown of four banks of gaming consoles 602, 604, 606, 608. The associated pathway 620 runs proximate to each of the banks 602-608. Clearly, other pathway configurations may be provided, even without changing the layout of the banks 602-608.

A terminal position on the track should be unambiguously associated with an adjacent gaming console. For example, the track of lights may include two different categories of light. A first type is positioned at intervals along the track, corresponding to the position of gaming consoles in the banks. The second type of light, which may be more numerous, occupies the pathway between the first types. Only the first type of light can mark a terminal location, and the second type contributes in giving an apparent continuity of motion along the track.

The track 620 is preferably a peripheral device on the network infrastructure 201, controllable from software running on the coordinating server 205.

In another arrangement, the pathway 620 is a physical pathway such as a tube, channel or set of tracks, along which a physical object is moved under the control of the coordinating software. The physical object may be a character that stops at a randomly selected location to indicate that a proximate gaming console 114 is a winning console in the feature.

Where in the foregoing description reference has been made to integers having known equivalents, then those equivalents are hereby incorporated herein as if individually set forth.

Those skilled in the relevant arts will appreciate that modifications and additions to the embodiments of the present invention may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A method of running a feature on a gaming system comprising a plurality of gaming consoles linked by a communication network, the method comprising:
defining a spatial sequence for the plurality of gaming consoles;
selecting at least one of the gaming consoles as a terminus;
activating the gaming consoles in turn to emit a predefined output, the activation cycling through the gaming consoles according to the spatial sequence; and
halting the cycle of activation at the terminus.

2. A method according to claim 1 comprising awarding a prize to a player at the terminus.

3. A method according to claim 1 wherein the predefined output emitted by the gaming consoles is selected from the group consisting of:
a visible output from a source of illumination on the gaming consoles having a specified duration; and
an audible output from a sound source on the gaming consoles.

4. A method according to claim 1 wherein the plurality of gaming consoles is a subset of a larger group of gaming consoles and the method comprises designating the plurality of gaming consoles as participating machines for the feature.

5. A method according to claim 1 comprising offering players at the participating machines the option of entering the feature.

6. A method according to claim 5 wherein the method comprises offering players the option of multiple entries into the feature.

7. A method according to claim 5 wherein the at least one terminus is selected from participating machines at which at least one entry into the feature has been received.

8. A method according to claim 5 wherein each entry provides an equal chance of selection as a terminus.

9. A method according to claim 5 wherein the method comprises charging an entry fee for each entry into the feature.

10. A method according to claim 9 wherein the entry fee is deducted from promotional credits accumulated by players at the gaming consoles.

11. A method according to claim 9 comprising adding received entry fees to a jackpot.

12. A method according to claim 2 wherein the prize comprises at least one of:
promotional credits drawn from a jackpot; and
prizes from a prize list.

13. A method according to claim 1 wherein the spatial sequence comprises a plurality of paths through the plurality of gaming consoles and said activating step activates two or more paths concurrently.

14. A method according to claim 13 wherein said step of selecting a terminus selects a plurality of participating machines.

15. A method according to claim 1 comprising receiving an input from a player at one of the gaming consoles and checking whether the input coincides with a specified interval during which the gaming console is activated in said activating step.

16. A method according to claim 15 comprising awarding a reward if the input coincides with the specified interval.

17. A method according to claim 15 comprising stopping the cycle of activation at a gaming console if an input is received to coincide with the specified interval.

18. A method according to claim 15 comprising increasing the specified interval as the cycle of activation progresses.

19. A method according to claim 1 wherein said cycle of activation has a definable interval between activation of sequential gaming consoles, the definable interval being variable over the cycle of activation.

20. A method according to claim 1 wherein the cycle of activation slows down prior to said halting of the cycle.

21. A method of running a feature on a gaming system comprising a plurality of gaming consoles, the method comprising:
defining a pathway associated with the plurality of gaming consoles;
activating a visual sequence that follows the pathway;
halting the visual sequence at a selected location on the pathway;
designating one of the gaming consoles associated with the selected location as a winning console in the feature.

22. A method according to claim 21 wherein the pathway is a spatial sequence of the gaming consoles and the visual sequence comprises activating sources of illumination of the gaming consoles according to the spatial sequence.

23. A method according to claim 21 wherein the pathway comprises a track of light sources proximate to the plurality of gaming consoles and the visual sequence comprises sequentially activating light sources along the track.

24. A method according to claim 21 wherein the pathway comprises a physical track proximate to the plurality of gaming consoles and the visual sequence comprises movement of an object along the physical track.

25. A gaming system comprising:
a plurality of gaming machines comprising light-emitting outputs and audio outputs; and
a computational device in communication with the plurality of gaming machines and programmed to:
define a spatial sequence for the gaming machines;
select at least one of the gaming consoles as a terminus;
activate the gaming consoles in turn to emit a predefined output, the activation cycling through the gaming consoles according to the spatial sequence; and
halt the cycle of activation at the terminus.

26. A gaming system according to claim 25 further comprising a track of light sources proximate to the plurality of gaming consoles, wherein the computational device is programmed to sequentially activate the light sources dependent on the spatial sequence.

27. A gaming system according to claim 25 further comprising a track proximate to the plurality of gaming consoles and means to move one or more objects along the track, wherein the computational device is programmed to control movement along the track dependent on the spatial sequence.

28. Instructions executable by a game controller to implement a method according to claim 1.
